(19) United States
(12) Patent Application Publication
(10) Pub. No.: US 2022/0333008 A1
(43) Pub. Date: Oct. 20, 2022

(54) Iridium Phosphorescent Material, Preparation Method Therefor, and Photophysical Properties Thereof

(71) Applicant: Korea University Research and Business Foundation, Sejong Campus, Sejong-si (KR)

(72) Inventors: Sang Ook KANG, Sejong-si (KR); Ho Jin SON, Suwon-si (KR)

(73) Assignee: Korea University Research and Business Foundation, Sejong Campus, Sejong-si (KR)

(21) Appl. No.: 17/743,018

(22) Filed: May 12, 2022

Related U.S. Application Data
(63) Continuation of application No. PCT/KR2020/015931, filed on Nov. 12, 2020.

(30) Foreign Application Priority Data
Nov. 13, 2019 (KR) 10-2019-0145233

(51) Int. Cl. C09K 11/06; C07F 15/00

(52) U.S. Cl. CPC C09K 11/06; C07F 15/0033; C09K 2211/185; C09K 2211/1029; C09K 2211/1007

(57) ABSTRACT

An iridium phosphorescent material comprises an iridium-containing core metal and a phenyl-pyridine ligand which is a bidentate ligand of the central metal and in which a steric hindrance phenyl group is introduced, wherein the steric hindrance phenyl is introduced at the ortho position of the phenyl group of the ligand. The present application relates to an iridium phosphorescent material comprising a phenylpyridine ligand in which a steric hindrance functional group is introduced, a method for preparing the same, and the photophysical properties of the material.

### TECHNICAL FIELD

The present application relates to an iridium phosphorescent material, a production method thereof, and photophysical properties thereof, and more particularly, to an iridium phosphorescent material, a production method thereof, and photophysical properties thereof, the iridium phosphorescent material having a central metal containing iridium; and a phenylpyridine ligand which is a coordinated to the central metal and includes a phenylpyridine ligand to which a sterically hindered functional group is introduced.

### BACKGROUND ART

In general, a color of a light emitting material for an organic light emitting diode (OLED) may be expressed by CIE1931 color coordinates. In this case, the reference color coordinate values for red, green, and blue colors are (0.735, 0.265), (0.274, 0.717), and (0.167, 0.009), respectively. In general, a light emitting material for a display implemented with RGB pixels is prepared to indicate a reference color coordinate value. However, the light emitting material for lighting may be prepared to be different from the reference color coordinate value depending on uses.

An emission wavelength region of the light emitting material may be determined by two or more main ligands. Thus, a research has been conducted on preparing a light-emitting material by selecting a main ligand with well-known luminous efficiency and providing an auxiliary ligand or introducing various substituents to the main ligand for fine adjustment of color coordinate values.

For example, Korean Unexamined Patent Publication No. 10-2014-0027315 (application no. 10-2013-7031102) discloses an organometallic complex containing aryl-2-[1,3,5]triazine as a ligand, which represents any one of a substituted or unsubstituted alkyl group having 1 to 4 carbon atoms, substituted or unsubstituted monocyclic saturated hydrocarbon having 5 to 7 carbon atoms, substituted or unsubstituted saturated hydrocarbon having 7 to 10 carbon atoms, and a substituted or unsubstituted aryl group having 6 to 10 carbon atoms at position 4 of the [1,3,5]triazine, and represents hydrogen, a substituted or unsubstituted alkyl group having 1 to 4 carbon atoms at position 6, in which the aryl represents a substituted or unsubstituted arylene group having 6 to 10 carbon atoms, and the metal represents group 9 elements or group 10 elements.

### DISCLOSURE

### Technical Problem

One technical object of the present invention is to provide an iridium phosphorescent material, a production method thereof, and photophysical properties thereof, the iridium phosphorescent material including a central metal containing iridium; and a phenyl-pyridine ligand which is a bidentate ligand of the central metal and to which a sterically hindered phenyl is introduced.

Another technical object of the present invention is to provide an iridium phosphorescent material, a production method thereof, and photophysical properties thereof, the iridium phosphorescent including a sterically hindered functional group and with a tuned emission wavelength and color coordinates.

The technical objects of the present invention are not limited to the above.

### Technical Solution

One technical object of the present invention is to provide an iridium phosphorescent material.

According to one embodiment, the iridium phosphorescent material may include an iridium-containing core metal and a phenyl-pyridine ligand which is a bidentate ligand of the central metal and in which a sterically hindered phenyl group is introduced, in which the sterically hindered phenyl is introduced at an ortho position of the phenyl group of the ligand.

According to one embodiment, the sterically hindered phenyl may include at least any one of phenyl, methylphenyl or 2,6-dimethylphenyl.

According to one embodiment, the iridium phosphorescent material may include one in which an emission wavelength increases, as a molecular weight of the sterically hindered phenyl increases.

According to one embodiment, the iridium phosphorescent material may include one in which optical properties are adjusted depending on a type of the sterically hindered phenyl, and thus a phosphorescence mechanism is changed.

According to one embodiment, the iridium phosphorescent material may include a green luminescent material.

According to one embodiment, the iridium phosphorescent material may include a homo-ligand iridium complex compound containing the ligand as a homo-ligand.

According to one embodiment, the iridium phosphorescent material may include a hetero-ligand iridium complex compound having the ligand as a main ligand and further containing an auxiliary ligand.

One technical object of the present invention is to provide a method for preparing an iridium phosphorescent material.

According to one embodiment, the method for preparing an iridium phosphorescent material may include: providing a ligand in which sterically hindered phenyl is introduced to a phenyl group of phenyl-pyridine; preparing a source solution containing the ligand and a iridium compound; and reacting the source solution to prepare the iridium phosphorescent material in which the ligand is tri-coordinated.

According to one embodiment, the method for preparing an iridium phosphorescent material may include: providing a ligand in which sterically hindered phenyl is introduced to a phenyl group of phenyl-pyridine; providing a first mixed solution containing the ligand and a iridium compound; reacting the first mixed solution to prepare an iridium dimer in which the ligand and iridium of the iridium compound are bound; providing a second mixed solution containing the iridium dimer and an auxiliary ligand; and reacting the second mixed solution to prepare the iridium phosphorescent material having the ligand as a main ligand.

### Advantageous Effects

According to an embodiment of the present invention, an iridium phosphorescent material can include: a central metal containing iridium; and a phenyl-pyridine ligand which is a bidentate ligand of the central metal and to which a sterically hindered phenyl group is introduced.

The sterically hindered phenyl maybe at least any one of phenyl, methylphenyl or 2,6-dimethylphenyl, and may be introduced at an ortho position of the phenyl group of the ligand. Accordingly, the sterically hindered phenyl may easily provide a steric hindrance effect to the iridium phosphorescent material.

In addition, an emission wavelength of the iridium phosphorescent material may increase, as a molecular weight of the sterically hindered phenyl increases. In other words, the emission properties of the iridium phosphorescent material may be changed according to a type of the sterically hindered phenyl, and thus the quantum yield and color coordinates of the iridium phosphorescent material may be adjusted.

### DESCRIPTION OF DRAWINGS

FIG. 1 is a reaction mechanism showing a method for preparing an iridium phosphorescent material according to an embodiment of the present invention

FIG. 2 is a view for explaining a structure and emission properties of an iridium phosphorescent material according to an embodiment of the present invention.

FIGS. 3 and 4 are images showing an optimal structure obtained by a density function theory (DFT) calculation for a ligand according to an embodiment of the present invention.

FIG. 5 is a graph showing an absorption spectrum of a ligand and an iridium complex compound according to an embodiment of the present invention.

FIG. 6 is a graph showing an emission spectrum of an iridium complex compound according to an embodiment of the present invention.

FIGS. 7 and 8 are images showing an optimal structure obtained by a density function theory (DFT) calculation for an iridium complex compound according to an embodiment of the present invention.

FIG. 9 is a graph showing a luminescence decay of an iridium complex compound according to an embodiment of the present invention over time.

FIG. 10 is a graph showing a non-luminescence decay rate constant of an iridium complex compound according to an embodiment of the present invention.

FIGS. 11 and 12 are views showing a frontier molecular orbital of an iridium complex compound according to an embodiment of the present invention.

FIG. 13 is a graph showing results of cyclic voltammetry of an iridium complex compound according to an embodiment of the present invention.

### MODE FOR INVENTION

Hereinafter, preferred embodiments of the present invention will be described in detail with reference to the accompanying drawings. However, the technical spirit of the present invention is not limited to the embodiments, but may be realized in different forms.

The embodiments introduced herein are provided to sufficiently deliver the spirit of the present invention to those skilled in the art so that the disclosed contents may become thorough and complete.

When it is mentioned in the specification that one element is on another element, it means that the first element may be directly formed on the second element or a third element may be interposed between the first element and the second element. Further, in the drawings, the thicknesses of the membrane and areas are exaggerated for efficient description of the technical contents.

Further, in the various embodiments of the present specification, the terms such as first, second, and third are used to describe various elements, but the elements are not limited to the terms. The terms are used only to distinguish one element from another element. Accordingly, an element mentioned as a first element in one embodiment may be mentioned as a second element in another embodiment. The embodiments illustrated here include their complementary embodiments. Further, the term “and/or” in the specification is used to include at least one of the elements enumerated in the specification.

In the specification, the terms of a singular form may include plural forms unless otherwise specified. Further, the terms “including” and “having” are used to designate that the features, the numbers, the steps, the elements, or combinations thereof described in the specification are present, and are not to be understood as excluding the possibility that one or more other features, numbers, steps, elements, or combinations thereof may be present or added.

Further, in the following description of the present invention, a detailed description of known functions or configurations incorporated herein will be omitted when it may make the subject matter of the present invention unnecessarily unclear.

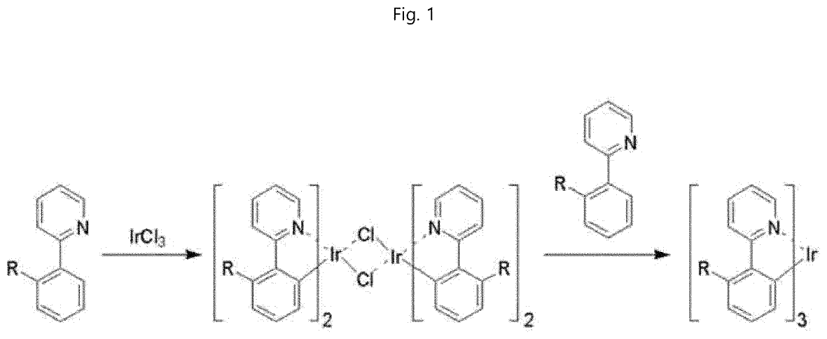

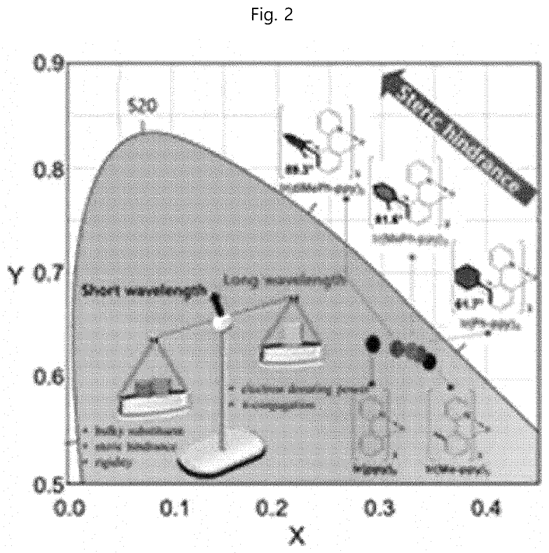

FIG. 1 is a reaction mechanism showing a method for preparing an iridium phosphorescent material according to an embodiment of the present invention, and FIG. 2 is a view for explaining a structure and emission properties of an iridium phosphorescent material according to an embodiment of the present invention.

According to one embodiment, an iridium phosphorescent material including: a central metal containing iridium; and a phenyl-pyridine ligand which is a bidentate ligand of the central metal and to which sterically hindered phenyl is introduced may be prepared. Herein, the sterically hindered phenyl maybe introduced at an ortho position of a phenyl group of the ligand, and the sterically hindered phenyl may be at least any one of phenyl, methylphenyl or 2,6-dimethylphenyl For example, the sterically hindered phenyl may be introduced at an ortho position of the phenyl group. Alternatively, for another example, the sterically hindered phenyl may be introduced at any one position of meta or para of the phenyl group.

According to one embodiment, the iridium phosphorescent material may include a homo-ligand iridium complex compound containing the ligand as a homo-ligand. In this case, as a molecular weight of the hindered phenyl increases, a steric hindrance effect may increase. Accordingly, an emission wavelength of the homo-ligand iridium complex compound may increase to a longer wavelength.

For example, as shown in FIG. 1, a source solution including an iridium compound and the ligand may be prepared. The source solution may be reacted to prepare an iridium dimer in which an iridium metal of the iridium compound and the ligand are bound. In this case, the source solution may include the iridium compound and the ligand at a molar ratio of 1:2 to 1:2.5. The ligand and the iridium compound prepared as described above may be reacted at a molar ratio of 1:2 to 1:2.5. Accordingly, the homo-ligand iridium complex compound may be prepared with a high yield.

As another example, the homo-ligand iridium complex compound may be prepared by reacting the iridium compound and the ligand at a molar ratio of 1:3 to 1:3.5. In other words, the homo-ligand iridium complex compound may be prepared in one step, and thus a time required for a process of preparing the homo-ligand iridium complex compound may be reduced.

According to another embodiment, the iridium phosphorescent material may be a hetero-ligand iridium complex compound having the ligand as a main ligand and further containing an auxiliary ligand. Accordingly, the auxiliary ligand may finely adjust an emission wavelength of the hetero-ligand iridium complex compound. For example, the auxiliary ligand may be at least any one selected from acetylacetonate (acac), phenylpyridine, pyridylimidazole, etc.

Specifically, for example, the hetero-ligand iridium complex compound may be prepared by reacting the auxiliary ligand and the iridium dimer prepared as shown in FIG. 1. In this case, the iridium dimer and the auxiliary ligand may be reacted at a molar ratio of 1:2 to 1:2.5.

According to one embodiment, as described above, the emission properties of the iridium phosphorescent material may be changed depending on a type of the sterically hindered phenyl. Specifically, as a volume of the sterically hindered phenyl increases (bulky), a bonding angle between a first plane including the sterically hindered phenyl and a second plane including the ligand may increase. In other words, as shown in FIG. 2, as the volume of the sterically hindered phenyl increases, a steric hindrance effect of the iridium phosphorescent material by the sterically hindered phenyl may increase. Specifically, for example, when the sterically hindered phenyl is phenyl, the bonding angle may be 61.2°. As another example, when the sterically hindered phenyl is phenyl, the bonding angle may be 61.2°. As still another example, when the sterically hindered phenyl is 2,6-dimethylphenyl, the bonding angle may be 89.3°.

In this case, according to one embodiment, the iridium phosphorescent material may be a green luminescent material. Thus, as the volume of the sterically hindered phenyl increases, an x value of C.I.E color coordinates of the iridium phosphorescent material may decrease, while an y value of the C.I.E color coordinates may increase at the same time. In other words, as the volume of the sterically hindered phenyl increases, an emission wavelength of the iridium phosphorescent material may increase.

As described above, the iridium phosphorescent material including: a central metal containing iridium; and a phenyl-pyridine ligand which is a bidentate ligand of the central metal and to which the sterically hindered phenyl is introduced may be prepared.

Specifically, the sterically hindered phenyl may be introduced at an ortho position of the phenyl group of the ligand. Accordingly, a greater steric hindrance effect may be provided to the iridium phosphorescent material as compared to a case in which the sterically hindered phenyl is introduced at a meta or para position of the phenyl group.

In addition, as the volume of the sterically hindered phenyl increases, the bonding angle between a plane including the ligand and a plane including the sterically hindered phenyl may increase, and thus an emission wavelength of the iridium phosphorescent material may increase.

In other words, as described above, the iridium phosphorescent material with adjusted emission properties depending on a type of the sterically hindered phenyl may be provided.

According to one embodiment, as described above, the iridium phosphorescent material may have the functional group having a large steric hindrance introduced, and an intermolecular attraction between the iridium phosphorescent materials may be weakened. Accordingly, a sublimation temperature of the iridium phosphorescent material may be reduced. Thus, a time and cost required for the sublimation process may be reduced.

In addition, the iridium phosphorescent material may have the functional group introduced, and solubility in an organic solvent may be increased. Accordingly, when the iridium phosphorescent material is provided to a display device, the light emitting layer including the iridium phosphorescent material maybe easily prepared by a solution process. The solution process may be any one selected from gravure-coating, bar-coating, die-coating, etc.

Hereinafter, a specific method for preparing an iridium complex compound according to an embodiment of the present invention described above and the results of evaluating properties will be described.

Preparing of Ligand (Ph-ppy) According to Experimental Example 1-1

A mixed solution of 2-phenylpyridine (0.5 mmol), palladium(II) acetate (0.025 mmol), benzoyl peroxide (1 mmol), 1 mL of acetonitrile and 1 mL of acetic acid was reacted at 100° C. for two hours.

The resulting product of the reaction may be cooled to room temperature, and filtered with silica gel. The resulting filtered product was concentrated and then dissolved in ethyl acetate. The resulting product was treated with a saturated aqueous solution of sodium hydrogen carbonate, and then extracted with dichloromethane. Sodium sulfate was added to the resulting extracted product to remove moisture, and then dried in a rotary evaporator. After that, the resulting product was subjected to silica gel column chromatography so as to prepare a ligand (Ph-ppy) according to Experimental Example 1-1.

Preparing of Ligand (MePh-ppy) According to Experimental Example 1-2

A mixed solution of 3-methyl-2-phenylpyridine (0.5 mmol), palladium(II) acetate (0.025 mmol), benzoyl peroxide (1 mmol), 1 mL of acetonitrile and 1 mL of acetic acid was reacted at a temperature of 100° C. for two hours.

The resulting product of the reaction may be cooled to room temperature, and filtered with silica gel. The resulting filtered product was concentrated and then dissolved in ethyl acetate. The resulting product was treated with a saturated aqueous solution of sodium hydrogen carbonate, and then extracted with dichloromethane. Sodium sulfate was added to the resulting extracted product to remove moisture, and then dried in a rotary evaporator. After that, the resulting product was subjected to silica gel column chromatography so as to prepare a ligand (MePh-ppy) according to Experimental Example 1-2.

Preparing of Ligand (diMePh-ppy) According to Experimental Example 1-3

A mixed solution of 3 g (12.8 mmol) of 2-(2-bromophenyl) pyridine, 2.61 g (19.2 mmol) of 2,6-dimethylphenylboronic acid, 0.29 g (1.28 mmol) of palladium(II) acetate, 0.71 g (2.56 mmol) of triphenylphosphine oxide, 3.89 g (25.6 mmol) of cesium fluoride, and 120 mL of tetrahydrofuran was reacted at a temperature of 70° C. for 24 hours, while being stirred.

The resulting product of the reaction was extracted with ethyl acetate, washed with distilled water, and dried over magnesium sulfate.

The dried product was filtered to remove the solvent, and silica gel column chromatography was performed. In this case, a ligand (diMePh-ppy) according to Experimental Example 1-3 was prepared by using ethyl acetate:n-hexane at a volume ratio of 1:9 as a developing solution.

Preparing of Ligand (ppy) According to Comparative Example 1-1

A ligand (ppy) according to Comparative Example 1-1 was prepared by providing 2-phenylpyridine.

Preparing of Ligand (Me-ppy) According to Comparative Experimental Example 1-2

1.84 mL (20 mmol) of 2-bromopyridine, 4.08 g (30 mmol) of 2-methylphenylboronic acid, 231 mg (0.2 mmol) of tetrakis(triphenylphosphin)palladium(0), 5.52 g (40 mmol) of potassium carbonate, and 30 mL of ethanol were mixed, and then reacted under reflux at a temperature of 100° C. for 15 hours.

After the reaction was completed, 1 M aqueous solution of sodium hydroxide was added to the reaction product cooled to room temperature. After that, the resulting mixture was extracted with ethyl acetate solvent, and magnesium sulfate was added to the extracted reaction product to remove moisture. After removing the solvent, the resulting product was subjected to silica gel column chromatography so as to prepare a ligand (Me-ppy) according to Comparative Example 1-2.

Preparing of Iridium Complex Compound (Ir(Ph-ppy)3) According to Experimental Example 2-1

0.50 g (1.79 mmol) of iridium(III) chloride was added to a mixed solution of 1.04 g (4.48 mmol) of the ligand (Ph-ppy) according to Experimental Example 1-1, 30 mL of 2-ethoxyethanol and 10 mL of distilled water under a nitrogen atmosphere so as to prepare a mixture.

The mixture was reacted under reflux at a temperature of 130° C. for 12 hours or more while being stirred. After the reaction mixture was cooled to room temperature, 50 mL of distilled water was added to form a precipitate. The resulting precipitate was washed with hexane.

1.12 g (0.81 mmol) of the precipitate washed under a nitrogen atmosphere, 0.56 g (2.43 mmol) of the ligand (Ph-ppy) according to Experimental Example 1-1, 0.56 g (4.05 mmol) of potassium carbonate, and 5 mL of glycerol were mixed and then reacted under reflux at a temperature of 250° C. for 72 hours.

After the reaction product was cooled to room temperature, distilled water was added to carry out a phase separation. From the phase-separated reaction product, the organic layer was extracted with dichloromethane, and then magnesium sulfate was added to remove moisture. The mixture was subjected to flash chromatography to prepare an iridium complex compound (Ir(Ph-ppy)₃) according to Experimental Example 1-1 represented by <Formula 1> below.

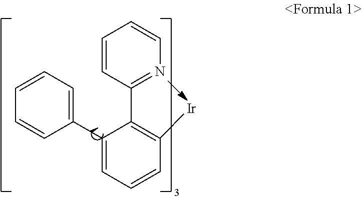

Preparing of Iridium Complex Compound (Ir(MePh-ppy)3) According to Experimental Example 2-2

The same method was performed as in Experimental Example 2-1, but 0.27 g (0.92 mmol) of iridium(III) chloride and 0.5 g (2.04 mmol) of the ligand (MePh-ppy) according to Experimental Example 1-2 were mixed instead of 0.50 g (1.79 mmol) of iridium(III) chloride and 1.04 g (4.48 mmol) of the ligand (Ph-ppy) according to Experimental Example 1-1. After that, 0.44 g (0.31 mmol) of the washed precipitate, 0.23 g (0.94 mmol) of the ligand (MePh-ppy) according to Experimental Example 1-2, 0.21 g (1.55 mmol) of potassium carbonate, and 3 mL of glycerol were mixed instead of 1.12 g (0.81 mmol) of the washed precipitate, 0.56 g (2.43 mmol) of the ligand (Ph-ppy) according to Experimental Example 1-1, 0.56 g (4.05 mmol) of potassium carbonate, and 5 mL of glycerol, so as to prepare an iridium complex compound (Ir(MePh-ppy)₃) according to Experimental Example 2-2 represented by <Formula 2> below.

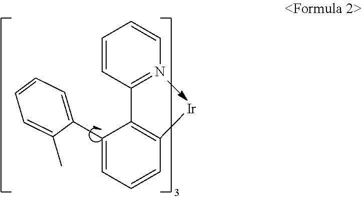

Preparing of Iridium Complex Compound (Ir(diMePh-ppy)3) According to Experimental Example 2-3

The same method was performed as in Experimental Example 2-1, but 0.52 g (1.74 mmol) of iridium(III) chloride and 1.00 g (3.86 mmol) of the ligand (diMePh-ppy) according to Experimental Example 1-3 were mixed instead of 0.50 g (1.79 mmol) of iridium(III) chloride and 1.04 g (4.48 mmol) of the ligand (Ph-ppy) according to Experimental Example 1-1. After that, 0.67 g (0.45 mmol) of the washed precipitate, 0.35 g (1.35 mmol) of the ligand (diMePh-ppy) according to Experimental Example 1-3, 0.31 g (2.25 mmol) of potassium carbonate, and 5 mL of glycerol were mixed instead of 1.12 g (0.81 mmol) of the washed precipitate, 0.56 g (2.43 mmol) of the ligand (Ph-ppy) according to Experimental Example 1-1, 0.56 g (4.05 mmol) of potassium carbonate, and 5 mL of glycerol, so as to prepare an iridium complex compound (Ir(diMePh-ppy)₃) according to Experimental Example 2-3 represented by <Formula 3> below.

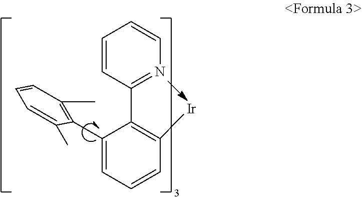

Preparing of Ligand Complex Compound (Ir(ppy)3) According to Comparative Example 2-1

The same method was performed as in Experimental Example 2-1, but the ligand (ppy) according to Comparative Example 2-1 was mixed instead of the ligand (Ph-ppy) according to Experimental Example 1-1, so as to prepare an iridium complex compound (Ir(ppy)₃) according to Comparative Example 2-1 represented by <Formula 4> below.

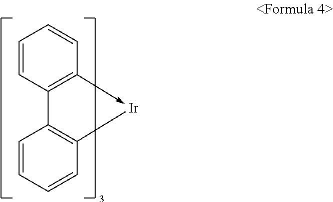

Preparing of Ligand Complex Compound (Ir(Me-ppy)3) According to Comparative Example 2-2

The same method was performed as in Experimental Example 2-1, but 0.50 g (1.79 mmol) of iridium(III) chloride was mixed with 1.04 g (4.48 mmol) of the ligand (Me-ppy) according to Comparative Example 1-2 instead of 1.04 g (4.48 mmol) of the ligand (Ph-ppy) according to Experimental Example 1-1. After that, 0.88 g (0.73 mmol) of the washed precipitate, 0.39 g (2.34 mmol) of the ligand (Me-ppy) according to Comparative Example 1-2, 0.54 g (3.9 mmol) of potassium carbonate, and 20 mL of glycerol were mixed instead of 1.12 g (0.81 mmol) of the washed precipitate, 0.56 g (2.43 mmol) of the ligand (Ph-ppy) according to Experimental Example 1-1, 0.56 g (4.05 mmol) of potassium carbonate, and 5 mL of glycerol, so as to prepare an iridium complex compound (Ir(Me-ppy)₃) according to Comparative Example 1-2 represented by <Formula 5> below.

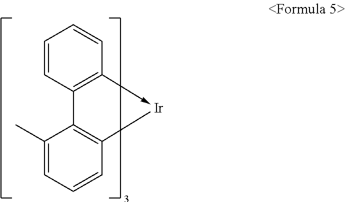

The functional groups of ligands of iridium complex compounds according to Comparative Examples 2-1 to 2-2 and Experimental Examples 2-1 to 2-3 as described above are shown in <Table 1> below.

TABLE 1

| | Functional group |
|---|---|
| Comparative | — |
| Example 2-1 | |
| Comparative | Methyl |
| Example 2-2 | |
| Experimental | Phenyl (sterically hindered phenyl) |
| Example 2-1 | |
| Experimental | Methylphenyl(sterically hindered phenyl) |
| Example 2-2 | |
| Experimental | 2,6-dimethylphenyl (sterically hindered phenyl) |
| Example 2-3 | |

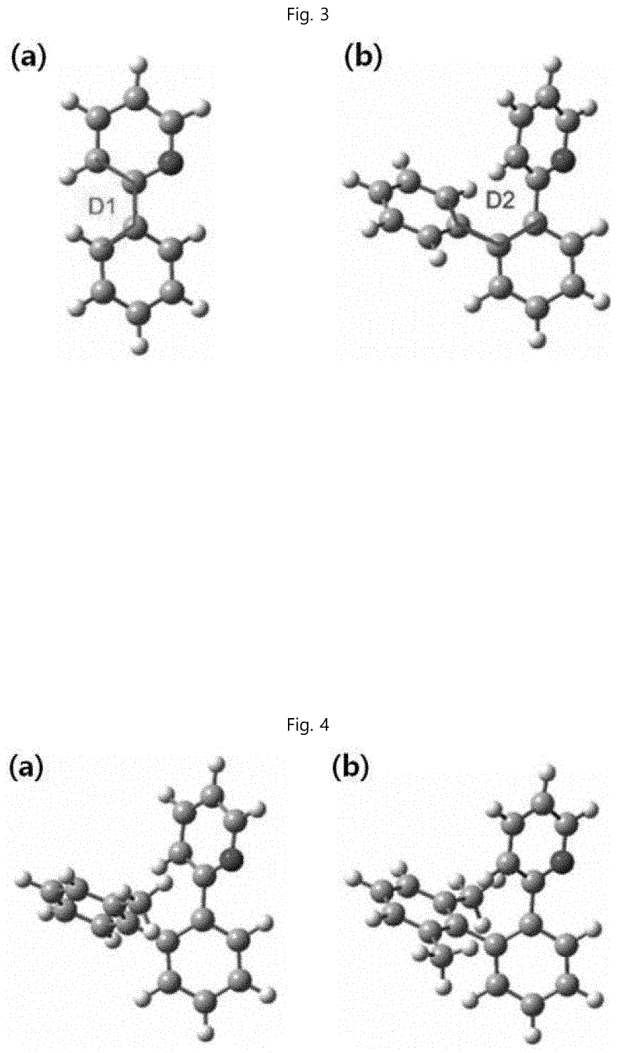

FIGS. 3 and 4 are images showing an optimal structure obtained by a density function theory (DFT) calculation for a ligand according to an embodiment of the present invention.

Referring to FIGS. 3 and 4, a dihedral angle of the ligands according to Comparative Example 1-1 and Experimental Examples 1-1 to 1-3 can be confirmed. As shown in FIG. 3, a dihedral angle (D1) including a bond between phenyl and pyridine in the phenyl-pyridine ligand, and a dihedral angle (D2) including a phenyl group of the phenyl-pyridine ligand and a functional group bound to the phenyl group are shown in <Table 2> below.

TABLE 2

| | D1 (°) | D2 (°) |
|---|---|---|
| Comparative | 23.3 | — |
| Example 1-1 | | |
| Experimental | 45.4 | 52.3 |
| Example 1-1 | | |
| Experimental | 44.0 | 69.3 |
| Example 1-2 | | |
| Experimental | 43.6 | 75.2 |
| Example 1-3 | | |

As can be understood from <Table 2>, it can be seen that the ligands (Ph-ppy, MePh-ppy, and diMePh-ppy) include a functional group and an angle (D1) between a plane including phenyl of phenyl-pyridine and a plane including pyridine thereof increases. In contrast, it can be confirmed that, as a molecular weight of the functional group (sterically hindered ligand) increases, the steric hindrance effect increases, and thus a dihedral angle (D1) of the phenyl-pyridine ligands (Ph-ppy, MePh-ppy and diMePh-ppy) decreases, while an angle D2 between a plane including the phenyl and a plane including the functional group increases.

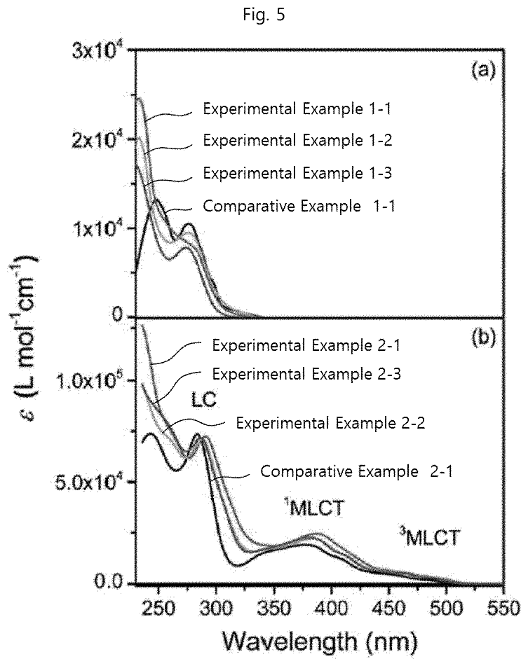

FIG. 5 is a graph showing an absorption spectrum of a ligand and an iridium complex compound according to an embodiment of the present invention.

Referring to (a) of FIG. 5, it can be seen that the phenyl-pyridine ligand (ppy) has a peak at 276 and 248 nm. In this case, it can be seen that the phenyl-pyridine ligands (Ph-ppy, MePh-ppy and diMePh-ppy) further include the functional group, and the peak at 248 nm is shifted to a shorter wavelength at 230 nm, and an intensity of the absorption peak further increases.

As described above with reference to <Table 2>, the dihedral angle (D1) of the phenyl-pyridine ligands (Ph-ppy, MePh-ppy and diMePh-ppy) increases, and thus a π-conjugation between the phenyl and the pyridine may be reduced. Accordingly, the peak may be shifted to a shorter wavelength. In addition, the phenyl group of the phenyl-pyridine ligands (Ph-ppy, MePh-ppy and diMePh-ppy) further includes the functional group (sterically hindered phenyl), and the π-conjugation increases, and thus an intensity of the absorption peak at 230 nm may increase.

Referring to (b) of FIG. 5, the iridium complex compound was confirmed to have a π-π* transition (LC) at 275 nm, a spin-allowed metal-ligand charge transfer (¹MLCT) at 325 to 430 nm, and a spin-forbidden metal-ligand charge transfer (³MLCT) in a range exceeding 430 nm. In this case, it can be seen that the iridium complex compound further includes the functional group (sterically hindered phenyl), and the absorption peak is shifted to a longer wavelength. In addition, it can be seen that the iridium complex compound further includes the functional group, and an intensity of the absorption peak increases, but as a molecular weight of the functional group increases, the intensity decreases.

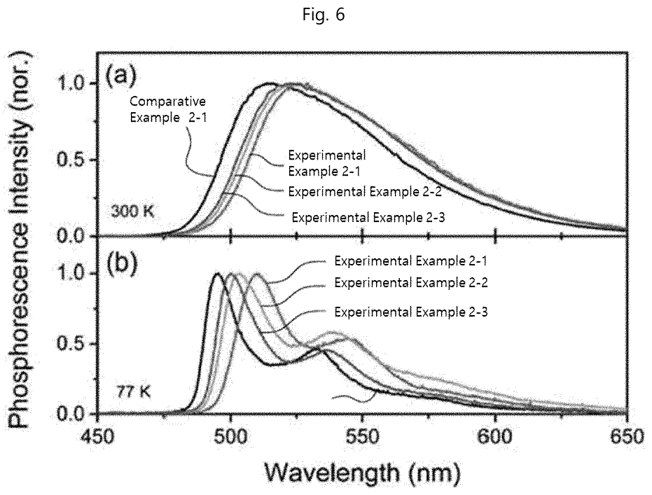

FIG. 6 is a graph showing an emission spectrum of an iridium complex compound according to an embodiment of the present invention.

Referring to FIG. 6, a maximum emission wavelength, luminous efficiency, luminescence and non-luminescence decay rate constants, etc., of the iridium complex compound at room temperature (300K) and a cryogenic temperature (77K) are shown in <Table 3>.

TABLE 3

| | 300k | | | | | 77k | |
|---|---|---|---|---|---|---|---|
| | λₘₐₓ (nm) | τₚ (μs) | φp (%) | kᵣ (10⁵s⁻¹) | kᵣ (10⁴s⁻¹) | λₘₐₓ (nm) | τₚ (μs) |
| Comparative | 513 | 1.52 | 97 | 6.4 | 1.8 | 495 | 4.14 |
| Example | | | | | | | |
| 2−1 | | | | | | | |
| Comparative | 527 | 0.64 | 73 | 11 | 42 | 506 | 4.78 |
| Example | | | | | | | |
| 2−2 | | | | | | | |
| Experimental | 527 | 1.36 | 93 | 6.8 | 5.5 | 509 | 3.22 |
| Example | | | | | | | |
| 2−1 | | | | | | | |
| Experimental | 524 | 1.41 | 91 | 6.5 | 5.9 | 503 | 3.58 |
| Example | | | | | | | |
| 2−2 | | | | | | | |
| Experimental | 522 | 1.33 | 88 | 6.6 | 9.2 | 499 | 3.73 |
| Example | | | | | | | |
| 2-3 | | | | | | | |

Referring to (b) of FIG. 6 and <Table 3>, it can be seen for the iridium complex compound that a peak of the emission spectrum is shifted to a shorter wavelength at a cryogenic temperature (77K) compared to room temperature (300K). In addition, it can be seen that the iridium complex compound exhibits a vibronic structure in the emission spectrum. Accordingly, it can be seen that the solvent used for the measurement of the emission spectrum at a cryogenic temperature is not rearranged, but a glassy matrix is formed. It was confirmed that one peak of short wavelength among the two peaks is a peak of a 0-0 vibration band, and the other is a peak of a 0-1 vibration band. In this case, an intensity (I₀₋₀/I₀₋₀) of the 0-1 vibration band compared to that of the 0-0 vibration band was calculated to be 0.45 to 0.58. Accordingly, it can be seen that the functional group does not substantially affect the change of the vibronic structure of the light emission. In contrast, as shown in (a) of FIG. 6, it can be seen that a stretching mode of a carbon-carbon bond connecting the phenyl-pyridine ligand occurs at room temperature, and thus the iridium complex compound does not exhibit a substantially vibronic structure.

As can be understood from (b) of FIG. 6 and <Table 3>, it can be seen that the iridium complex compound further includes the functional group (sterically hindered phenyl), and the π-conjugation increases, and thus an emission peak of the iridium complex compound is shifted to a longer wavelength. In contrast, when further including the functional group, the functional group may be arranged at a right angle to the phenyl group, as a molecular weight of the functional group increases, and thus the π-conjugation may decrease. Thus, as the molecular weight of the functional group increases, an emission peak of the iridium complex compound may be shifted to a shorter wavelength. In addition, as the molecular weight of the functional group increases, a methyl group may be further included, and thus an electron donor ability of the functional group may increase. Accordingly, the emission wavelength of the iridium complex compound may be shifted to a shorter wavelength.

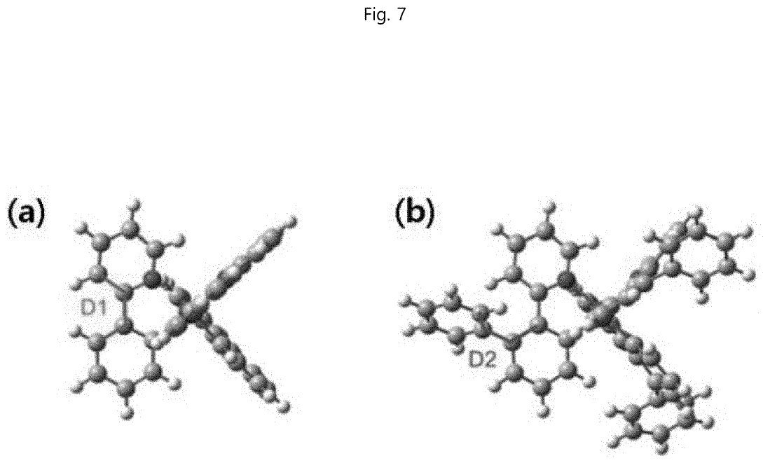

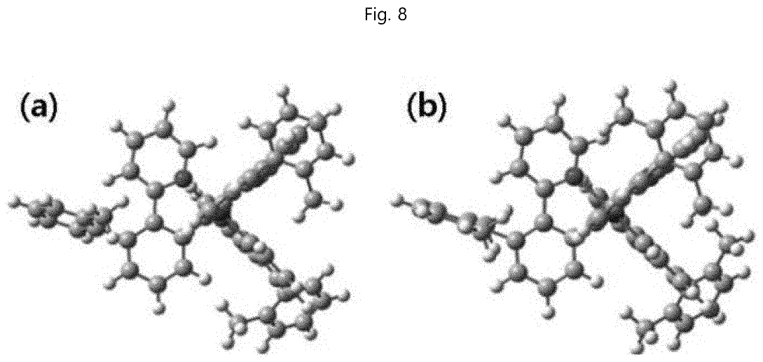

FIGS. 7 and 8 are images showing an optimal structure obtained by a density function theory (DFT) calculation for an iridium complex compound according to an embodiment of the present invention.

Referring to FIGS. 7 and 8, as described above with reference to FIGS. 3 and 4, the dihedral angle (D1) of the phenyl-pyridine ligand and the dihedral angle (D2) between the phenyl-pyridine ligand and the functional group are shown in <Table 4> below.

TABLE 4

| | D1 (°) | | D2 (°) | |
|---|---|---|---|---|
| Comparative | 0.67 | | — | |
| Example 2-1 | | | | |
| Experimental | 12.45 | (12.37) | 61.74 | (61.76) |
| Example 2-1 | | | | |
| Experimental | 4.48 | (4.96) | 81.58 | (81.02) |
| Example 2-2 | | | | |
| Experimental | 1.55 | (1.51) | 89.33 | (89.15) |
| Example 2-3 | | | | |

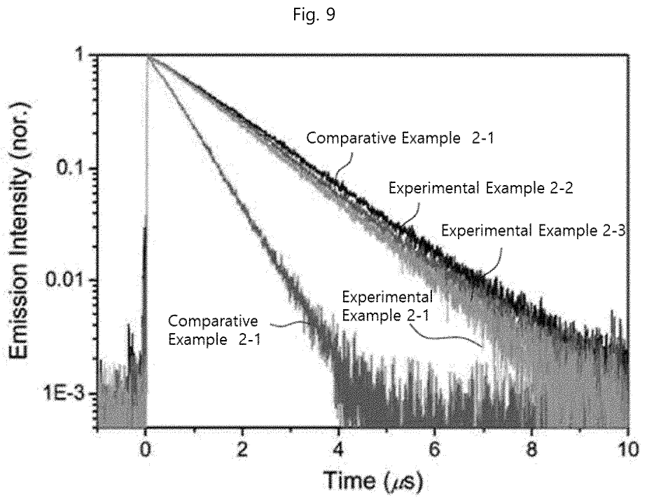

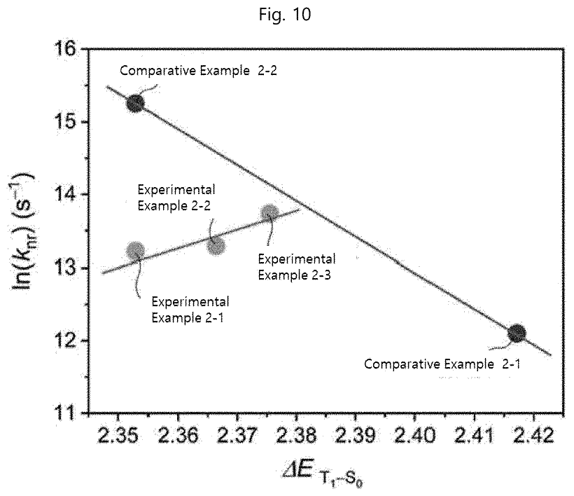

As can be understood from <Table 4>, it was confirmed that the dihedral angle (D1) of the phenyl-pyridine ligand is in the range of 0.67 to 12.5°. Accordingly, it can be seen that the phenyl-pyridine ligand binds to the iridium metal and has a substantially planar shape. In other words, it can be seen that a plane including phenyl in the phenyl-pyridine ligand and a plane including phenyl therein are substantially the same plane. Accordingly, it can be seen that the dihedral angle (D2) of the iridium complex compound is increased more than the dihedral angle (D2) described above with reference to <Table 2>. In this case, it can be seen that the dihedral angle (D2) of the iridium complex compound increases as the molecular weight of the functional group (sterically hindered phenyl) increases, as described above with reference to <Table 2>. FIG. 9 is a graph showing a luminescence decay of an iridium complex compound according to an embodiment of the present invention over time, and FIG. 10 is a graph showing a non-luminescence decay rate constant of an iridium complex compound according to an embodiment of the present invention.

Referring to FIG. 9, a phosphorescence lifetime (τₚ) of the iridium complex compound may be confirmed at room temperature (300K). Accordingly, the phosphorescence lifetime (τₚ) is shown in above <Table 3>. In this case, the luminescence decay rate constant (kᵣ) according to <Equation 1> below and the non-luminescence decay rate constant (kₙᵣ) according to <Equation 2> below may be calculated by using the values of the phosphorescence lifetime and quantum efficiency (φₚ).

$${k}_{r} = \frac{ϕ p}{τ p} \qquad < Equation 1 >$$

$${k}_{nr} = \frac{{k}_{r}}{ϕ p} - {k}_{r} \qquad < Equation 2 >$$

Referring to <Table 3>, it can be seen that the iridium complex compounds according to Experimental Examples 1-1 to 1-3 and Comparative Example 1-1 have substantially the same luminescence decay rate constant. In contrast, it can be seen that the non-luminescence decay rate constants are different from each other. In this case, the non-luminescence decay rate constant maybe analyzed by an energy gap law represented by <Equation 3> below.

$$ln ( {k}_{n r} ) ∝ ( - \frac{Υ}{h ω M} ) \times ( Δ E ) \qquad < Equation 3 >$$

Here, ΔE is an energy difference between an excited state of triplet and a ground state thereof, γ is a molecular parameter, and ωM is a maximum and major vibrational frequency possible in a system.

Accordingly, as shown in FIG. 10, it can be seen for the iridium complex compounds (Ir(Me-ppy)₃) according to Comparative Examples 2-1 and 2-2 that a log function value of the non-luminescence decay rate constant has a linear relationship with regard to the energy difference (ΔE). Accordingly, as shown in FIG. 9, it can be seen for the iridium complex compound (Ir(Me-ppy)₃) according to Comparative Example 2-2 that phosphorescent emission becomes exponentially lower than that of the iridium complex compound (Ir(ppy)₃) according to Comparative Example 2-1.

In contrast, it can be seen that the iridium complex compounds according to Experimental Examples 1-1 to 1-3 deviate from a linear relationship of the iridium complex compounds according to above Comparative Examples 1-1 and 1-2. Alternatively, it can be seen that a log function value of the non-luminescence decay rate constant increases as the energy difference ΔE increases. In this case, the functional group (sterically hindered phenyl) provides a rigid environment to a fluidic solution in which the iridium complex compound is dissolved, and thus may deviate from the linear relationship. In addition, it can be seen that the functional group (sterically hindered phenyl) further includes the methyl group, and a degree of freedom of vibration and rotation increases, and thus the non-luminescence decay rate tends to increase, as the energy difference (ΔE) increases.

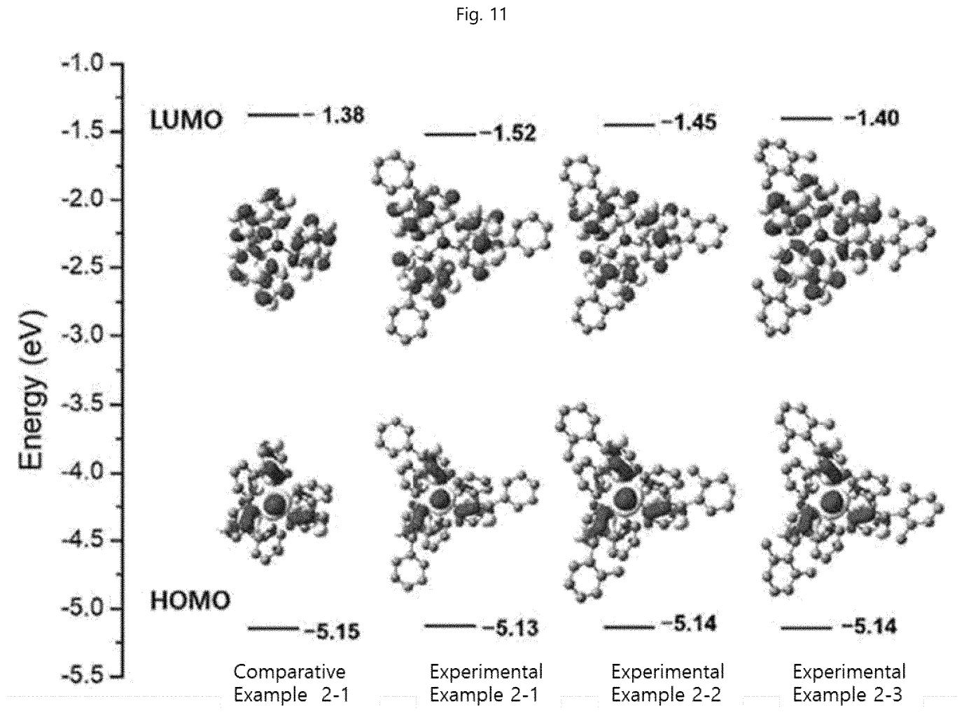

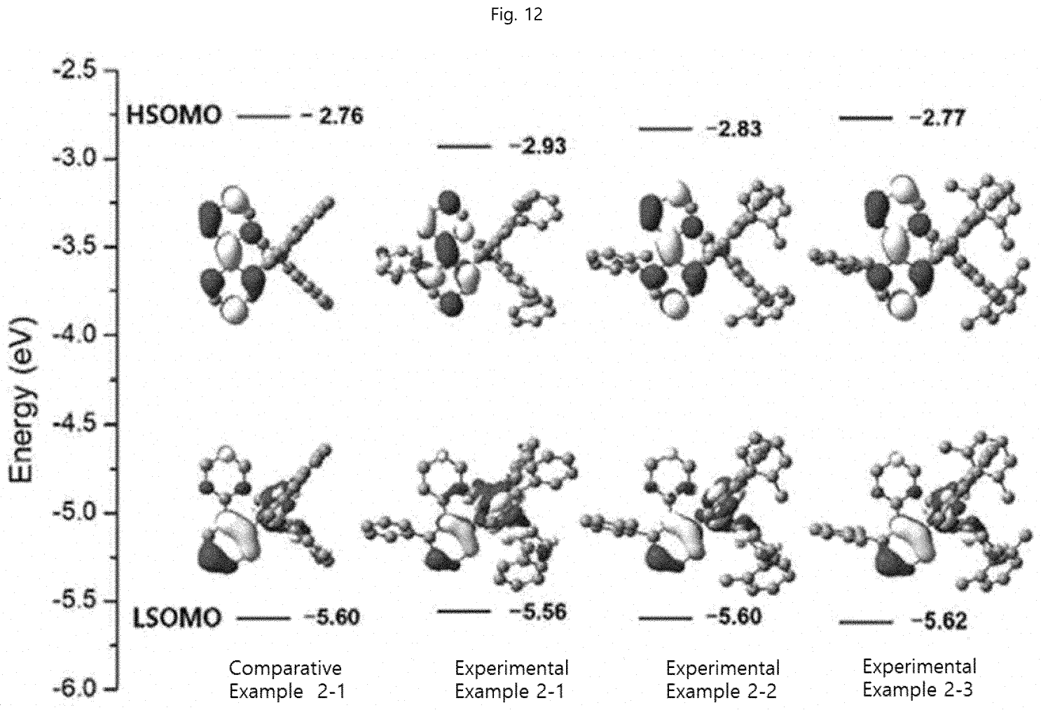

FIGS. 11 and 12 are views showing a frontier molecular orbital of an iridium complex compound according to an embodiment of the present invention.

Referring to FIGS. 11 and 12, a highest occupied molecular orbital (HOMO) of the iridium complex compound, a lowest unoccupied molecular orbital (LUMO), an energy difference between the highest occupied molecular orbital and the lowest unoccupied molecular orbital, a singly occupied lowest molecular orbital (LSOMO), a singly occupied highest molecular orbital (HSOMO), and an energy difference between the singly occupied lowest molecular orbital (LSOMO) and the singly occupied highest molecular orbital (HSOMO) are shown in <Table 5> below.

| | HOMO | LUMO | ΔE | LSOMO | HSOMO | ΔEₛ |
|---|---|---|---|---|---|---|
| | (eV) | (eV) | (eV) | (eV) | (eV) | (eV) |
| Comparative | −5.15 | −1.38 | 3.77 | −5.60 | −2.76 | 2.84 |
| Example | | | | | | |
| 2−1 | | | | | | |
| Experimental | −5.13 | −1.52 | 3.61 | −5.56 | −2.93 | 2.63 |
| Example | | | | | | |
| 2−1 | | | | | | |
| Experimental | −5.14 | −1.45 | 3.68 | −5.60 | −2.83 | 2.77 |
| Example | | | | | | |
| 2−2 | | | | | | |
| Experimental | −5.14 | −1.40 | 3.73 | −5.62 | −2.77 | 2.85 |
| Example | | | | | | |
| 2-3 | | | | | | |

Referring to FIG. 11, it can be seen that the highest occupied molecular orbital (HOMO) of the iridium complex compound is distributed in the phenyl group of the phenyl-pyridine ligand and the iridium metal. In this case, it can be seen that the functional group (sterically hindered phenyl) has the steric hindrance effect, and thus the highest occupied molecular orbital (HOMO) is not distributed. In addition, it can be seen that the lowest unoccupied molecular orbital (LUMO) of the iridium complex compound is distributed in the phenyl-pyridine ligand, and mainly distributed in the pyridine of the ligand. As shown in (b) of FIG. 5, it can be seen that the iridium complex compound further includes the functional group (sterically hindered phenyl), and the spin-allowed metal-ligand charge transfer (¹MLCT), the spin-forbidden metal-ligand charge transfer (³MLCT) and an inter-ligand charge transfer (ILCT) overlap, and thus the energy difference (ΔE) appears. In addition, it can be seen that the iridium complex compound substantially coincides with the highest occupied molecular orbital (HOMO), and thus shows a difference in absorption spectrum at a long wavelength for stabilization of the lowest unoccupied molecular orbital (LUMO). As shown in FIG. 12, an electron configuration was confirmed in the triplet of the iridium complex compound. In the electron configuration of triplet, unpaired electrons may be distributed in the singly occupied lowest molecular orbital (LSOMO) and the singly occupied highest molecular orbital (HSOMO), respectively. In this case, the singly occupied lowest molecular orbital (LSOMO) may be mainly distributed in the phenyl group of the phenyl-pyridine ligand and the iridium metal. In addition, the singly occupied highest molecular orbital (HSOMO) may be mainly distributed in the phenyl-pyridine ligand.

Accordingly, the singly occupied lowest level molecular orbital (LSOMO) may correspond to the highest occupied molecular orbital (HOMO), and the singly occupied highest molecular orbital (HSOMO) may correspond to the lowest unoccupied molecular orbital (LUMO). In addition, it was confirmed that even an energy difference (ΔEₛ) between the singly occupied lowest molecular orbital (LSOMO) and the singly occupied molecular orbital (HSOMO) shows a similar trend.

A structural change was observed in the singlet and triplet of the iridium complex compounds according to Comparative Examples 2-1 to 2-2 and Experimental Examples 2-1 to 2-3 as described above. In this case, with regard to a distance between the phenyl and pyridine bonds of the phenyl-pyridine ligand (Cₚₕ—C_{py}), a dihedral angle (D_{ph-py}) between the planes including the phenyl and the pyridine, a bond length between the iridium metal and nitrogen of the pyridine (Ir—N_{py}), and a bond length between the iridium metal and carbon of the phenyl (Ir—Cₚₕ), a difference between the singlet and the triplet is shown in <Table 6> below.

TABLE 6

| | ΔR_{S0-T1} | | | |
|---|---|---|---|---|
| | Cₚₕ—C_{py} (Å) | D_{ph-py} (°) | Ir—N_{py} (Å) | Ir—Cₚₕ (Å) |
| Comparative | 0.06 | 0.48 | 0.03 | 0 |
| Example 2-1 | | | | |
| Comparative | 0.06 | 1.03 | 0.03 | 0.04 |
| Example 2-2 | | | | |
| Experimental | 0.07 | 1.40 | 0.01 | 0.04 |
| Example 2-1 | | | | |
| Experimental | 0.07 | 3.67 | 0.02 | 0.05 |
| Example 2-2 | | | | |
| Experimental | 0.07 | 3.84 | 0.03 | 0.04 |
| Example 2-3 | | | | |

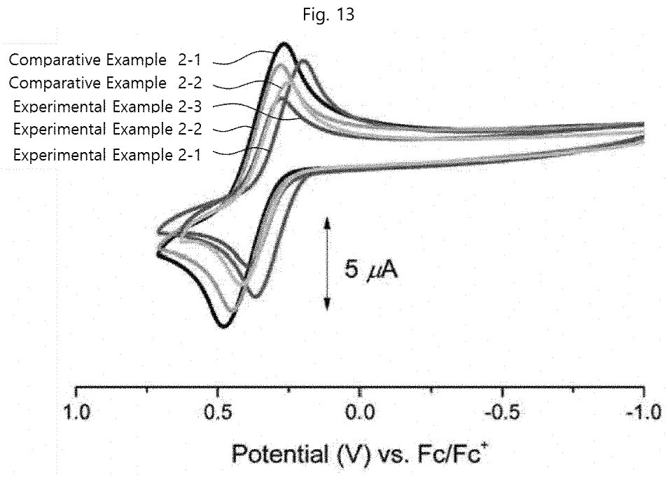

As can be seen from <Table 6>, it can be seen that the iridium ligand has substantially no structural difference between the singlet and the triplet. Accordingly, it can be seen that the functional group does not cause a structural difference in the singlet and the triplet. FIG. 13 is a graph showing results of cyclic voltammetry of an iridium complex compound according to an embodiment of the present invention.

Referring to FIG. 13, an oxidation potential (E_{1/2}^{ox}) of the iridium complex compounds according to Comparative Examples 2-1 to 2-2 and Experimental Examples 2-1 to 2-3 is shown in <Table 7> below.

TABLE 7

| | E_{1/2}^{ox} (eV) | E_{HOMO} (eV) | E_{LUMO} (eV) | E_{g} (eV) |
|---|---|---|---|---|
| Comparative | 0.38 | −5.18 | −2.67 | 2.51 |
| Example 2-1 | | | | |
| Comparative | 0.28 | −5.08 | −2.63 | 2.45 |
| Example 2-2 | | | | |
| Experimental | 0.37 | −5.17 | −2.73 | 2.44 |
| Example 2-1 | | | | |
| Experimental | 0.34 | −5.14 | −2.67 | 2.47 |
| Example 2-2 | | | | |
| Experimental | 0.33 | −5.13 | −2.64 | 2.49 |
| Example 2-3 | | | | |

As can be understood from FIG. 13 and <Table 7>, it can be seen that the oxidation potential of the iridium complex compounds according to Comparative Example 2-2 compared to Comparative Example 2-1 further includes an electron donor group (EDG) as the functional group, and decreases. In contrast, it was observed that the oxidation potential of the iridium complex compounds according to Experimental Examples 2-1 to 2-3 shows a decrease lower than that of the iridium complex compound (Ir(Me-ppy)₃) according to Comparative Example 2-2. Accordingly, it can be seen that a degree of improvement in electron density by the electron donor group is not large in the iridium complex compound due to the steric hindrance effect of the functional group (sterically hindered phenyl).

Although the invention has been described in detail with reference to exemplary embodiments, the scope of the present invention is not limited to a specific embodiment and should be interpreted by the attached claims. In addition, those skilled in the art should understand that many modifications and variations are possible without departing from the scope of the present invention.

### INDUSTRIAL APPLICABILITY

The electrode according to an embodiment of the present application may be used for a secondary battery, a super capacitor or the like.

1. An iridium phosphorescent material comprising:
a central metal containing iridium; and
a phenyl-pyridine ligand which is a bidentate ligand of the central metal and in which a sterically hindered phenyl group is introduced, wherein
the sterically hindered phenyl is introduced at an ortho position of the phenyl group of the ligand.

2. The iridium phosphorescent material of claim 1, wherein the sterically hindered phenyl comprises at least any one of phenyl, methylphenyl or 2,6-dimethylphenyl.

3. The iridium phosphorescent material of claim 1, wherein an emission wavelength increases as a molecular weight of the sterically hindered phenyl increases.

4. The iridium phosphorescent material of claim 1, wherein the iridium phosphorescent material includes a green luminescent material.

5. The iridium phosphorescent material of claim 1, wherein the iridium phosphorescent material includes a homo-ligand iridium complex compound containing the ligand as a homo-ligand.

6. The iridium phosphorescent material of claim 1, wherein the iridium phosphorescent material includes a hetero-ligand iridium complex compound having the ligand as a main ligand and further containing an auxiliary ligand.

7. A method for preparing an iridium phosphorescent material, the method comprising:
providing a ligand in which sterically hindered phenyl is introduced to a phenyl group of phenyl-pyridine;
preparing a source solution containing the ligand and a iridium compound; and
reacting the source solution to prepare the iridium phosphorescent material according to claim 5 in which the ligand is tri-coordinated.

8. A method for preparing an iridium phosphorescent material, the method comprising:
providing a ligand in which sterically hindered phenyl is introduced to a phenyl group of phenyl-pyridine;
providing a first mixed solution containing the ligand and a iridium compound;
reacting the first mixed solution to prepare an iridium dimer in which the ligand and iridium of the iridium compound are bound;
providing a second mixed solution containing the iridium dimer and an auxiliary ligand; and
reacting the second mixed solution to prepare the iridium phosphorescent material according to claim 6, having the ligand as a main ligand.
